(19) United States
(12) Patent Application Publication
(10) Pub. No.: US 2025/0358067 A1
(43) Pub. Date: Nov. 20, 2025

(54) PREAMBLE CLASSIFICATION INDICATION AND SIGNALING FOR AN ENHANCED LONG RANGE PPDU

(71) Applicant: NXP USA, Inc., AUSTIN, TX (US)

(72) Inventors: Priyanka Bansal, Lakheri (IN); Hari Ram Balakrishnan, Chennai (IN); Sudhir Srinivasa, Los Gatos, CA (US); Liwen Chu, San Ramon, CA (US); Rui Cao, Sunnyvale, CA (US); Rong Zhang, San Jose, CA (US); Hongyuan Zhang, Fremont, CA (US)

(21) Appl. No.: 19/207,822

(22) Filed: May 14, 2025

(30) Foreign Application Priority Data
May 14, 2024 (IN) 202441037827
Aug. 22, 2024 (IN) 202441063354
Aug. 22, 2024 (IN) 202441063362

(51) Int. Cl. H04L 5/00

(52) U.S. Cl. CPC H04L 5/0044

(57) ABSTRACT

Methods and apparatus are described for performing Enhanced Long Range (ELR) wireless communications. In a method, a wireless device generates a legacy portion of an ELR physical layer protocol data unit (PPDU), the legacy portion including at least a legacy short training field (L-STF), a legacy long training field (L-LTF), a legacy signal (L-SIG) field, and a universal signaling (U-SIG) field. The U-SIG field includes at least one bit defined to provide an ELR PPDU indication for identifying an ELR PPDU. The wireless device further generates an ELR portion of the ELR PPDU, the ELR portion including an ELR preamble. The legacy portion of the ELR PPDU may further include an additional symbol (e.g., including a BSS color indication and/or ELR PPDU indication) following the U-SIG field. The wireless device transmits the ELR PPDU over a wireless interface for reception by a second device.

### CROSS REFERENCE TO RELATED APPLICATIONS

The present U.S. Utility Patent Application claims priority pursuant to 35 U.S.C. § 119(a) to Indian Provisional Patent Application Ser. No. 202441037827, entitled “LEGACY PREAMBLE DEFINITION OF ELR PPDU”, filed May 14, 2024, Indian Provisional Patent Application Ser. No. 202441063362, entitled “USIG SIGNALING INDICATION FOR ELR PPDU”, filed Aug. 22, 2024, and Indian Provisional Patent Application Ser. No. 202441063354, entitled “EXTENDED RANGE PPDU SIGNALING DESIGN AND RX FSM”, filed Aug. 22, 2024, the contents of each are incorporated herein by reference in their entirety and made part of the present U.S. Utility Patent Application for all purposes.

### TECHNICAL FIELD

This disclosure relates generally to wireless communications, and more specifically to extended range signaling in wireless communications.

### BACKGROUND

Wireless local area networks (WLANs) have evolved rapidly over the past couple of decades, including WLANs that conform to the Institute of Electrical and Electronics Engineers (IEEE) 802.11 family of standards. In such WLANs, wireless devices including Access Points (APs) and client stations (STAs) wirelessly transmit and receive physical layer protocol data units (PPDUs). As various new services and deployment scenarios are supported by these wireless devices, the devices may be expected to transmit and receive signals over longer ranges. To extend the range that the PPDUs are transmitted and received, the IEEE 802.11ax and IEEE 802.11be amendments to the IEEE 802.11 standard define a legacy extended range PPDU. The IEEE 802.11b amendment also describes direct sequence spread spectrum (DSSS) communications to support an extended range.

### BRIEF DESCRIPTION OF THE DRAWINGS

One or more embodiments will now be described by way of example only with reference to the accompanying drawings, in which:

FIG. 1 illustrates an example of a wireless local area network (WLAN) in accordance with embodiments of the present disclosure;

FIG. 2 illustrates an example of an Enhanced Long Range (ELR) physical layer protocol data unit (PPDU) in accordance with an embodiment of the present disclosure;

FIG. 3 illustrates an example of a universal signaling (U-SIG-1) field including an ELR PPDU indication in accordance with an embodiment of the present disclosure;

FIG. 4 illustrates an example of a U-SIG-2 field including an ELR PPDU indication in accordance with an embodiment of the present disclosure;

FIG. 5 illustrates another example of a U-SIG-2 field including an ELR PPDU indication in accordance with an embodiment of the present disclosure;

FIG. 6 is a table illustrating examples of ELR PPDU indication bits and ELR signaling bits of U-SIG fields in accordance with embodiments of the present disclosure;

FIG. 7 is a table illustrating examples of ELR PPDU indication bits and ELR signaling bits of High Efficiency SIG (HE-SIG) fields in accordance with embodiments of the present disclosure;

FIG. 8 is a logic diagram illustrating an example process for generating an ELR PPDU including an ELR PPDU indication in accordance with an embodiment of the present disclosure; and

FIG. 9 illustrates example functions associated with single carrier-frequency division multiplexed transmission in accordance with an embodiment of the present disclosure.

### DETAILED DESCRIPTION

The various implementations described in the following description relate generally to extended range physical layer protocol data units (PPDU) formats to support new wireless communication protocols, and more particularly to Enhanced Long Range (ELR) PPDU formats that support extended range wireless communication features associated with the IEEE 802.11bn amendment (also referred to as Ultra High Reliability or “UHR” or “Wi-Fi 8”), and future generations, of the IEEE 802.11 standard while also providing coexistence with legacy wireless devices. In some aspects, a wireless device generates a legacy portion of an ELR physical layer protocol data unit (PPDU) including a legacy short training field (L-STF), a legacy long training field (L-LTF), a legacy signal (L-SIG) field, and a universal signaling (U-SIG) field. The U-SIG field can include one or more bits that are redefined to provide an ELR PPDU indication(s) and various bits that are utilized to provide ELR signaling (e.g., for ELR PPDU detection and classification).

As used herein, the term “non-legacy” may refer to frame structures, physical layer (PHY) protocol data unit (PPDU) formats and communication protocols conforming with the IEEE 802.11bn amendment to the IEEE 802.11 standard (“802.11bn”) as well as future generations/amendments. In contrast, the term “legacy” may be used herein to refer to frame structures, PPDU formats and communication protocols conforming to the IEEE 802.11be (also referred to as Extremely High Throughput or “EHT” or “Wi-Fi 7”) or IEEE 802.11ax (also referred to as High Efficiency or “HE” or “Wi-Fi 6/6E”) amendments to the IEEE 802.11 standard, or carlier generations of the IEEE 802.11 standard, but not conforming to all mandatory features of 802.11bn or future generations of the IEEE 802.11 standard.

Particular implementations of the subject matter described in the present disclosure can be implemented to realize one or more of the following potential advantages. By enabling extended range communications, aspects of the described subject matter may support gains in data throughput and reliability achievable in accordance with various features of the IEEE 802.11bn amendment to the IEEE 802.11 standard. For example, an ELR PPDU according to the present disclosure may be used to overcome a link budget imbalance between downlink and uplink wireless communications and achieve higher data rates as compared to legacy extended range PPDU formats and protocols. An ELR PPDU according to the present disclosure may also alleviate false CRC pass (CRC-PASS) issues that can occur in low SNR receivers, enable better coexistence with legacy devices, and support power saving features for high SNR receivers.

In another example, an ELR PPDU is transmitted by an AP device to a client station which is able to decode an extended range portion of the ELR PPDU when the client station might not be able to fully decode a legacy portion of the ELR PPDU. In this example, at least some fields of the legacy portion may be defined by IEEE 802.11bn such that legacy devices compliant with IEEE 802.11a/g/n/a/ax/be have the capability to decode the legacy portion of the new ELR PPDU and perform corresponding clear channel assessment (CCA) for better coexistence with UHR devices. The ELR portion of the PPDU is appended to the legacy portion, and may include one or more repetitions of one or more of an ELR-STF (e.g., a UHR-STF), an ELR-LTF (e.g., a UHR-LTF), an ELR-SIG field, and an ELR Data field (e.g., a UHR Data field). The repetition may be in time, in frequency within a channel bandwidth, or both in time and in frequency. In an example, a time domain repetition of the ELR-STF includes a polarity change of one or more waveforms representative of one or more bits of a binary sequence in the ELR-STF and in symbols of the ELR-LTF, and the ELR-SIG field and ELR data field are repeated by repeating a respective binary sequence in resource units (RUs) of symbols (e.g., in accordance with a dual carrier modulation with duplication (DCM+DUP) with a 106-tone, 52-tone, or 26-tone resource unit (RU)). A client station which receives the ELR portion combines signals of the one or more repetitions for a given field to increase a signal to noise ratio (SNR) of the one or more fields in the ELR portion to facilitate the decoding. Certain well known instructions, protocols, structures, and techniques have not been shown in detail in order not to obfuscate the description.

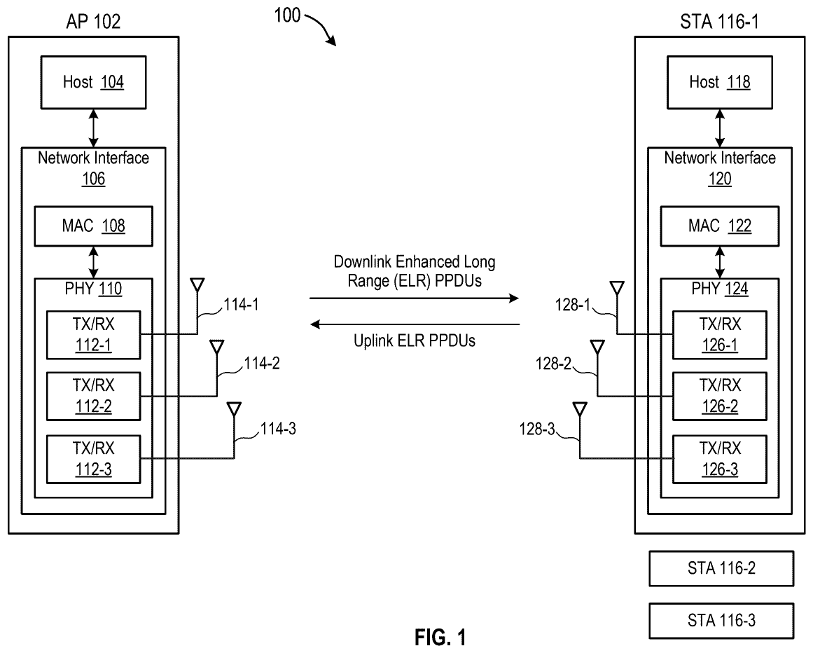

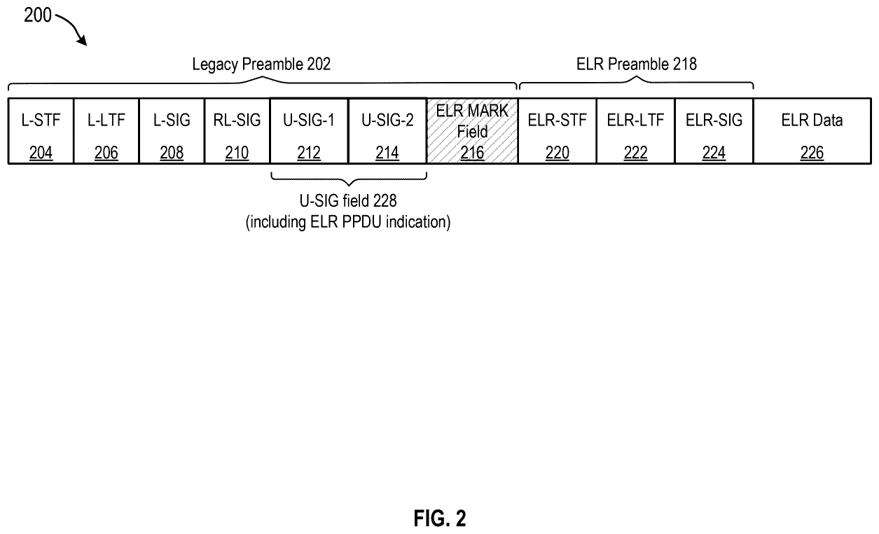

FIG. 1 illustrates an example of a wireless local area network (WLAN) 100 in accordance with embodiments of the present disclosure. The illustrated WLAN includes a wireless access point (AP) 102 and one or more wireless client stations 116 (e.g., STA 116-1, STA 116-2, and STA 116-3). The AP102 of this example is configured to transmit downlink Enhanced Long Range (ELR) PPDUs and receive uplink ELR PPDUs. The ELR PPDUs can have a format and contents such as described in greater detail below with reference to any of the embodiments of FIGS. 2-8.

The illustrated AP 102 includes a host processor 104 coupled to a network interface 106. The network interface 106 includes a medium access control (MAC) processing unit 108 and a physical layer (PHY) processing unit 110. The PHY processing unit 110 includes a plurality of transceivers 112-1, 112-2 and 112-3 (e.g., transmitters and/or receivers) coupled to a respective plurality of antennas 114-1, 114-2 and 114-3. Although three transceivers 112 and three antennas 114 are illustrated in FIG. 1, in other embodiments the AP 102 includes other suitable numbers (e.g., 1, 2, 4, 5, etc.) of transceivers 112 and antennas 114 in other embodiments. In one embodiment, the MAC processing unit 108 and the PHY processing unit 110 are configured to operate in compliance with the IEEE 802.11bn amendment to the IEEE 802.11 standard.

The illustrated WLAN 100 also includes one or more wireless client stations 116. Three client stations 116 shown as 116-1, 116-2, and 116-3 are illustrated in FIG. 1, but the WLAN 100 may include other suitable numbers (e.g., 1, 2, 3, 5, 6, etc.) of client stations 116 in various scenarios and embodiments. At least one of the client stations 116 (e.g., client station 116-1) is configured to operate in compliance with the IEEE 802.11bn amendment to the IEEE 802.11 standard to communicate with the AP 102.

The client station 116-1 includes a host processor 118 coupled to a network interface 120 which includes a MAC processing unit 122 and a PHY processing unit 124. The PHY processing unit 124 includes a plurality of transceivers 126-1, 126-2 and 126-3, and the transceivers 126 are coupled to a respective plurality of antennas 128-1, 128-2 and 128-3. Although three transceivers 126 and three antennas 128 are illustrated in FIG. 1, the client station 116-1 includes other suitable numbers (e.g., 1, 2, 4, 5, etc.) of transceivers 126 and antennas 128 in other embodiments.

In various embodiments, the PHY processing unit 110 of the AP 102 is configured to generate and transmit (downlink) data units via the antenna(s) 114 over an air interface and the PHY processing unit 124 of the client station 116-1 is configured to receive the (downlink) data units via the antenna(s) 128 over the air interface. Similarly, the PHY processing unit 110 of the client station 116-1 is configured to generate and transmit (uplink) data units via the antenna(s) 128 and the PHY processing unit 110 of the AP 102 is configured to receive the (uplink) data units via the antenna(s) 114. In an example, the data units may be physical layer data units (PPDUs) for communicating data between the AP 102 and the client station 116-1 and the PPDUs (and fields therein) may be transmitted as a waveform in a downlink or uplink direction.

In embodiments, the network interface 106 of the AP 102 and the network interface 120 of one or more of the client stations 116 are configured to generate, transmit and receive ELR PPDUs having an extended range format to increase a range and/or a signal-to-noise (SNR) ratio associated with transmitting, receiving, classifying, and successfully decoding the ELR PPDUs exchanged in the WLAN 100. In an example, the ELR PPDUs are compliant with the IEEE 802.11bn (or later) amendment to the IEEE 802.11 standard, and include a legacy portion with legacy fields of one or more legacy IEEE 802.11 standards for backwards compatibility with legacy devices and an enhanced long range (ELR) portion with non-legacy fields of a non-legacy IEEE 802.11 standard which can be decoded by non-legacy devices.

The range extension features of the ELR PPDU may allow a client station 116 to decode the ELR portion of the ELR PPDU at an extended range. Decoding is a process of determining a valid pattern of bits of the received ELR PPDU referred to as decoded bits. In an example, the decoding may involve performing a parity check or CRC verification to determine whether the decoding is successful. A downlink ELR PPDU transmitted by AP 102 may solicit a response from a client station 116 in the form of an uplink ELR PPDU.

In an embodiment, when operating in single-user mode, the AP 102 transmits a data unit to a single client station (DL SU transmission), or receives a data unit transmitted by a single client station (UL SU transmission), without simultaneous transmission to, or by, any other client station. When operating in multi-user mode, the AP 102 transmits a data unit that includes multiple data streams for multiple client stations (DL MU transmission), or receives data units simultaneously transmitted by multiple client stations (UL MU transmission). For example, in multi-user mode, a data unit transmitted by the MLD includes multiple data streams simultaneously transmitted by the AP 102 to respective client stations using respective spatial streams allocated for simultaneous transmission to the respective client stations and/or using respective sets of OFDM tones corresponding to respective frequency sub-channels allocated for simultaneous transmission to the respective client stations. In a further example, the AP 102 and/or client station(s) 116 may be configured as a multi-link device (MLD). In another example, the AP 102 and/or one or more of the client stations 116 are configured to transmit and receive PPDUs over a plurality of wireless links, including one or more of a 2.4 Gigahertz (GHz) link, a 5 GHz link, a 6 GHz link, and a mmWave link (e.g., a 45 GHz link and/or a 60 GHz link).

In an example, the illustrated AP 102 may be connected to a distribution system (DS) through a distribution system medium (DSM). The distribution system may be a wired network or a wireless network that is connected to a backbone network such as the Internet. The DSM may be a wired medium (e.g., Ethernet cables, telephone network cables, or fiber optic cables) or a wireless medium (e.g., infrared, broadcast radio, cellular radio, or microwaves). Although some examples of the DSM are described, the DSM is not limited to the examples described herein. In another example, the AP 102 and/or client stations 116 may be implemented in a laptop, a desktop personal computer (PC), a mobile phone, remote sensor, or other communications device that supports at least one WLAN communications standard (e.g., at least one IEEE 802.11 standard).

In an example, one or more of the AP 102 and client stations 116 may be implemented with circuitry such as one or more of analog circuitry, mixed signal circuitry, memory circuitry, logic circuitry, and processing circuitry that executes code stored in a memory that when executed by the processing circuitry performs the disclosed functions. For example, the AP 102 and client stations 116 may include memory storing operational instructions (software, program instructions, computer instructions, etc.) and one or more processing modules, operably coupled to one or more wireless transceivers and the memory, configured to execute the operational to generate an ELR PPDU.

In another example, a network interface 106/120 includes one or more integrated circuit (IC) devices. In this example, at least some of the functionality of a MAC processing unit 108/122 and at least some of the functionality of the PHY processing unit 110 can be implemented on a single IC device. As another example, at least some of the functionality of the MAC processing unit 108 is implemented on a first IC device, and at least some of the functionality of the PHY processing unit 110 is implemented on a second IC device.

In a further example, the ELR PPDU formats described herein can be utilized in 2.4 GHz, 5 GHZ, and 6 GHz bands for uplink communications, and in the 2.4 GHz band for downlink communications. In another example, a ELR PPDU may have a 20 MHz PPDU bandwidth, a single spatial stream, and utilize UHR-MCSs 0 or 1 with four times frequency domain duplication (e.g., over 52-tone RUs) in a primary 20 MHz channel.

FIG. 2 illustrates an example of an Enhanced Long Range (ELR) physical layer protocol data unit (PPDU) 200 in accordance with an embodiment of the present disclosure. The ELR PPDU 200 of this example includes a legacy preamble 202 (also referred to hercin as a “legacy portion”), an ELR preamble 218, and ELR Data field 226, which are transmitted as a waveform. The legacy preamble 202 includes legacy fields which legacy 802.11 devices are able to decode for co-existence while the ELR preamble 218 may include one or more ELR fields so that next generation devices (e.g., Wi-Fi 8 UHR devices) are able to transmit and receive data of the ELR Data field 226 with increased range and lower SNR. In an example, a bandwidth of the legacy preamble 202 and the ELR portions of the ELR PPDU 200 is the same to provide co-existence with legacy devices.

The legacy preamble 202 of this example includes a legacy short training field (L-STF) 204, a legacy long training field (L-LTF) 206, a legacy signal (L-SIG) field 208, a repeated L-SIG (RL-SIG) field 210, a U-SIG-1 field 212, and a U-SIG-2 field 214. U-SIG-1 field 212 and U-SIG-2 field 214 are collectively referred to herein as U-SIG field 228. The L-STF 204 is used by a recipient device to detect the start of the PPDU or portion thereof and to establish orthogonal frequency division multiplexed/access (OFDM/A) symbol timing for data detection, i.e. frame acquisition and time synchronization. The L-LTF 206 is used for channel estimation/training for information detection. Channel estimation is a process of determining channel characteristics (e.g., a frequency response) of a channel in which the PPDU is transmitted. The L-SIG field 208 includes information for data decoding and coexistence such as a 12 bit packet length value (LENGTH), rate information, etc. In an example, LENGTH is signaled to spoof legacy devices for purposes of clear channel assessment (CCA), and non-legacy devices can decode a TXOP for CCA. In addition, a non-legacy device (e.g., an intended receiver) may also derive a Nsym (with may also be referred to as Length) value from the L-SIG field 208. However, as L-SIG LENGTH decoding may not be reliable, this information may be repeated in the ELR-SIG field 224. In an example, a number of data symbols (Nsym/Length) subfield can be directly signaled in the ELR-SIG field 224 utilizing fewer than 12 bits (e.g., 8 or 9 bits), thereby saving 3-4 bits of signaling and simplifying packet length calculations by receiving devices.

In an example, the L-SIG field 208 may be repeated in time and the repetition is included in the repeated RL-SIG field 210 of the legacy preamble 202 such that the L-SIG field 208 is repeated twice. The repetition may allow increased range and SNR associated with receipt of the L-SIG field 208. To further extend the range, a transmission power of a waveform of one or more of the L-STF 204 and the L-LTF 206 may be boosted to 3 dB.

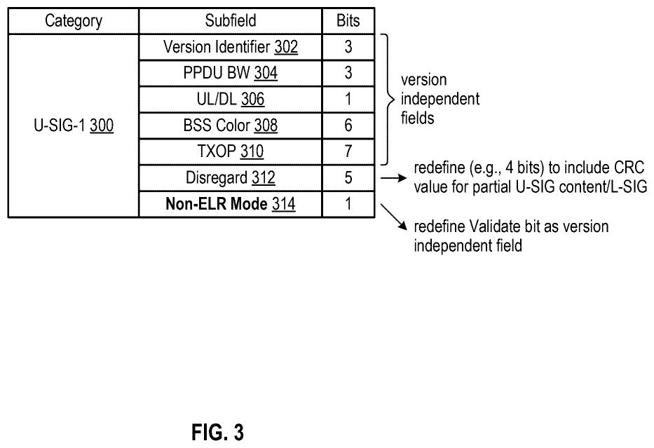

The U-SIG field 228 in the legacy preamble 202 may include an indication of a version of the physical layer communication of IEEE 802.11 in a three-bit PHY identifier, an uplink/downlink flag, Basic Service Set (BSS) color, transmission (TX) opportunity (TXOP) duration, bandwidth, etc. In the illustrated ELR PPDU, the U-SIG field 228 includes a U-SIG-1 field 212 and a U-SIG-2 field 214, examples of which are described in greater detail with reference to FIGS. 3-7. As described herein, the U-SIG field 228 can include one or more bits that are redefined to provide an ELR PPDU indication(s) and various bits that are utilized to provide ELR signaling (e.g., for ELR PPDU detection and classification).

The legacy preamble 202 may be modulated on an orthogonal frequency division multiplexed (OFDM) signal which defines subcarriers for transmitting the fields of the legacy preamble 202 and as a result range extension is also limited by a maximum peak to average ratio (PAPR) of the waveform representing the PPDU which IEEE 802.11 specifies. IEEE 802.11b defines a single-carrier binary sequence design which demonstrates range extension benefits over OFDM associated with 802.11 ax and 802.11 be. However, the carrier is only defined for a 2.4 GHz band and does not co-exist with IEEE 802.11a such that the format cannot be extended into a 5 GHZ and 6 GHz band without also causing backward compatibility issues for legacy devices.

In some examples, one or more transition symbols may be optionally added after the U-SIG field 228 in the legacy preamble 202 preceding the ELR preamble 218. In the illustrated example, an ELR-MARK field 216 is included. The ELR-MARK field 216 may be a symbol, such as an OFDM symbol, which spans a channel bandwidth and has a predefined duration, and may signal a transition between the U-SIG field 228 and the ELR preamble 218. The optional nature of inclusion in the ELR PPDU 200 is illustrated by the cross-hatching. In an example, a non-legacy wireless device receiving the ELR PPDU 200 may need to determine a receiver state machine based on a U-SIG decoding CRC check. In the event that the U-SIG decoding fails, e.g., a CRC check does not pass, the wireless device needs to reset receive time domain parameters, such as CFO and sample frequency offset (SFO) compensation, while ELR preamble detection logic is still running. The ELR-MARK field 216 may provide some buffer time such that the ELR preamble will not arrive before the receive time domain parameters are reset. Thus, the ELR preamble detection will not be affected by the status of the legacy preamble detection. In one example, the ELR-MARK field 216 is defined as a signaling field (with predefined tone patterns). In another example, the ELR-MARK field 216 is a predefined sequence, which can further include a BSS color indication (e.g., a value of 0 to 63) or other unique sequence associated with an AP for use by receiving devices to determine if the received PPDU is an ELR PPDU and if the ELR PPDU is from OBSS. In a further example, the ELR-MARK field 216 carries a unique/defined sequence used to indicate an ELR PPDU format for purposes of further improving ELR PPDU classification.

The ELR-Mark field 216 is designed to assist in ELR PPDU classification at low SNR. A receiving device may operate in a “sniffer” mode to detect over-the-air packets. If the ELR-Mark field 216 includes BSS-Color information, the receiving device may need to check all sequences, which may add complexity (and cause a receiver PHY to no longer be agnostic to an operation mode). In addition, at higher SNR regions the U-SIG field content may be decodable by a receiving device(s), and the ELR-Mark field 216 may not be required.

To achieve range extension, the legacy preamble 202 is followed by the ELR preamble 218. By appending the legacy preamble 202 to the ELR preamble 218, the ELR PPDU 200 is able to co-exist with the 802.11 legacy devices. In an example, a PPDU length in octets indicated in the L-SIG field 208 is backward compatible with legacy devices to detect the ELR PPDU 200 while the U-SIG field 228 provides both backward and forward compatibility. For example, the U-SIG field 228 is modulated with binary phase shift keying (BPSK), and the U-SIG field 228 may indicate a “PHY version identifier” which indicates a PHY version. As described herein, the “PHY version identifier” subfield (bit index (B0-B2)) in the U-SIG-1 field 212 (or other subfields) can be redefined in various ways to indicate that a PPDU is formatted as an ELR PPDU.

An unintended receiver (ELR capable or non-ELR capable) can use ELR PPDU indications of such fields to stop processing to prevent unnecessary power consumption when the ELR PPDU is received and is not able to be processed, and set corresponding network allocation vector (NAV) values to delay any transmissions for at least a PPDU duration. In an example, an OBSS STA receiving an ELR PPDU can use a signaled BSS color value to stop further processing as a non-ELR PPDU. For an in-BSS STA receiving an ELR PPDU, an association ID (STA-ID) value carried in repurposed fields (e.g., subfields of a U-SIG/HE-SIG-A field) can be used as a criteria to stop further processing for a EHT/UHR non-ELR PPDU. In an example, an in-BSS STA receives an ELR PPDU having a (Phy) Version Identifier value of 1 (indicating UHR), a matching BSS color, a PPDU Type and Compression Mode value of 3 (indicating an ELR PPDU format), and a valid CRC, but also a STA-ID that does not match its STA-ID. In this example, the in-BSS STA can stop further processing of the ELR PPDU (e.g., if the RSSI of the PPDU is above a threshold value).

The ELR portion of the illustrated example includes an ELR preamble 218 and a ELR Data field 226. The ELR preamble 218 includes an ELR short training field (ELR-STF) 220, an ELR long training field (ELR-LTF) 222, and an ELR signal (ELR-SIG) field 224. The ELR-STF 220 may be a predefined binary sequence used to detect the start of the ELR portion and provide symbol timing for data detection, i.e. frame acquisition and time synchronization. In one embodiment, the ELR-STF 220 consists of two parts: one binary sequence for synchronization followed by one binary sequence for STF ending and ELR-LTF 222 may not be included. In another embodiment, the ELR-STF 220 consists of one binary sequence followed by ELR-LTF 222. If the receiver is not able to detect the L-STF 204, the receiver will attempt to detect the ELR-STF 220. The ELR-LTF 222 defines a binary sequence for channel estimation/training by a receiver. In some examples, this field may be omitted for certain modulation schemes such as differential encoding for 802.11b.

The ELR-SIG field 224 includes information for data decoding. The ELR-SIG field 224 may include various parameters including a modulation and coding scheme (MCS) subfield, a coding subfield that indicates whether BCC or LDPC is used, a TXOP subfield, a number of symbols (Nsym) or Length subfield that indicates a number of ELR data symbols, a cyclic redundancy check (CRC), a BSS Color subfield, an association ID (STA-ID) subfield, an LDPC Extra Symbol or Segment subfield, a Pre-FEC Padding subfield, a CRC subfield, a Tail bits subfield(s), etc. In an example, the ELR-SIG field 224 includes two symbols (i.e., an ELR-SIG-1 subfield and an ELR-SIG-2 subfield). Forward error correction (FEC) coding may be defined for the ELR-SIG field 224 to enhance reliability, e.g. binary convolutional coding (BCC). The ELR Data field 226 which follows the ELR Preamble 218 includes a data payload defined by an ELR-data binary sequence. Forward error correction (FEC) coding may be defined to enhance data decoding reliability, e.g. BCC or low density parity check code (LDPC).

The ELR portion may be transmitted in various ways. In one example, a waveform representative of the binary sequences of the ELR portion may be defined with a low peak-to-average ratio (PAPR) such that the transmitter can increase the maximum transmit power to increase communication range or enhance receiver reception reliability. Because the legacy preamble 202 may already have a high PAPR, a power amplifier associated with the transceiver which transmits the ELR portion may back off by ˜10 dB to keep all samples which are to be transmitted in a linear region to accommodate the PAPR. The power amplifier may transmit the ELR portion with some peak samples into a non-linear region for range extension and an ER spectrum growth due to the non-linearity may result in a lower PAPR, close to 0 dB depending on binary sequence design. In an example, the ELR portion may be transmitted with a power similar to a peak power of the legacy preamble 202 with ˜10 dB gain, but in some cases, an increase in transmit power may be limited by a power spectral density. In another example, the transmit power of a waveform of the ELR portion may be set to a power boost such as 3 dB or the transmitter may set a power boost based on a historical transmit power range.

The binary sequence of the ELR-STF 220 may be modulated on a time domain waveform. Time domain modulation is defined as varying a modulation of a waveform over time. The binary sequence of the ELR-LTF 222, ELR-SIG field 224, and ELR Data field 226 may be transmitted based on single carrier (SC) time-domain multiplexing (TDM). A binary sequence may be directly modulated on a time domain waveform to generate different time domain signals for different binary sequences and additional spreading can be applied, e.g. 802.11b direct sequence spread spectrum (DSSS).

In another example, the modulation of one or more of the fields in the ELR preamble may be based on a single carrier (SC) frequency-domain multiplexing (FDM). Frequency domain multiplexing is defined as loading binary sequences to be transmitted onto subcarriers in a frequency band versus time domain signals, where different frequency bands may be assigned to different wireless devices. The ELR-STF 220 may be transmitted with one of the 802.11b DSSS, a zero correlation zone (ZCZ) spreading sequence, or a Golay sequence (defined in 802.11ad/ay). The ELR-LTF 222 may include a predefined binary sequence to estimate a channel of each subcarrier, and may be transmitted in a manner similar to the ELR-STF 220. The ELR-SIG field 224 and the ELR Data field 226 may be transmitted with SC-FDM. An LTF1 subfield of ELR-LTF 222 may be added before the ELR-SIG field 224 to indicate information to demodulate SIG content and an LTF2 subfield of the ELR-LTF 222 may be added to indicate information to demodulate ELR Data field 226 content. The information may indicate a tone mapping and the LTF2 may be included in the ELR-LTF 222 when a tone mapping of the subcarriers on which a binary sequence of the information are loaded and/or a bandwidth of the ELR Data field 226 is different from the ELR-SIG field 224. The tone mapping may be a process of selecting subcarriers in a set of subcarriers to transmit the binary sequence, where a subcarrier or tone is a defined frequency or frequencies in a channel bandwidth such as a 20 MHz channel having an amplitude and a phase. In an example, a bit or bits of the sequence may be modulated on the tone such as by binary phase shift keying (BPSK) or quadrature phase shift keying (QPSK) to form a waveform.

In extended range implementation scenarios, a legacy preamble may not have sufficient SNR for it to be decoded properly by an ELR-capable STA. For example, a considerable fraction of valid ELR PPDUs received by a STA may have a value in the PHY version Identifier field flipped to indicate a non-UHR version. In this situation, a matching BSS color may be received, and a CRC verification may still pass. The various ELR PPDU formats and U-SIG field contents described herein allow sufficient time for a receiver to process the legacy preamble portion until the ELR PPDU is detected.

In addition to other challenges associated with enhanced long range communications, a Finite State Machine (FSM) (used to define the different transitional states of a wireless STA during authentication and association with an AP) of a receiver of an ELR PPDU may need to wait for ELR-MARK symbol cross-correlation with a known pattern (e.g., in the frequency domain) before continuing with non-ELR classifications. This processing time may become an issue if a signaling field (e.g., a UHR-SIG field) which follows the U-SIG field has only one symbol. The various ELR PPDU indications of the U-SIG fields described herein can provide an FSM sufficient time to process a PPDU for classifications in parallel with ELR-Mark cross-correlation.

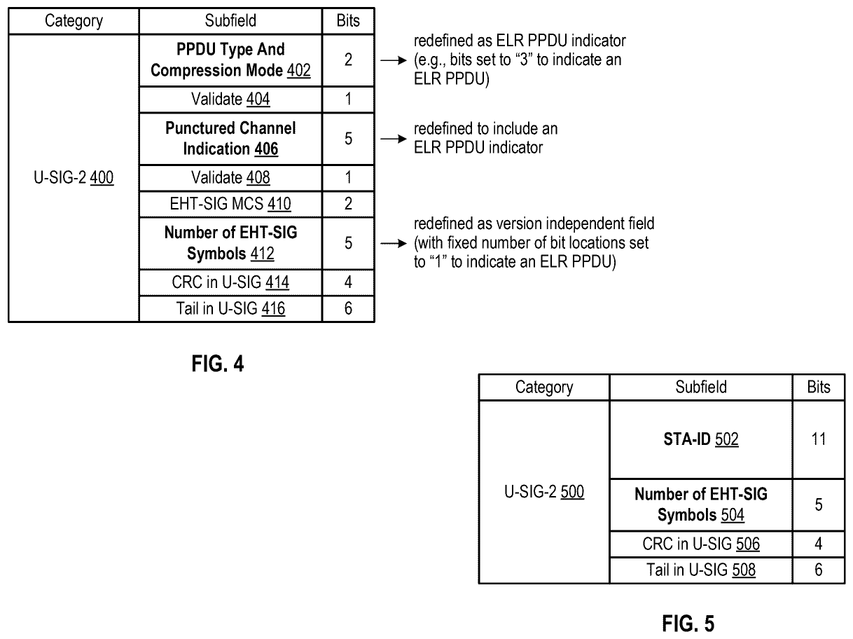

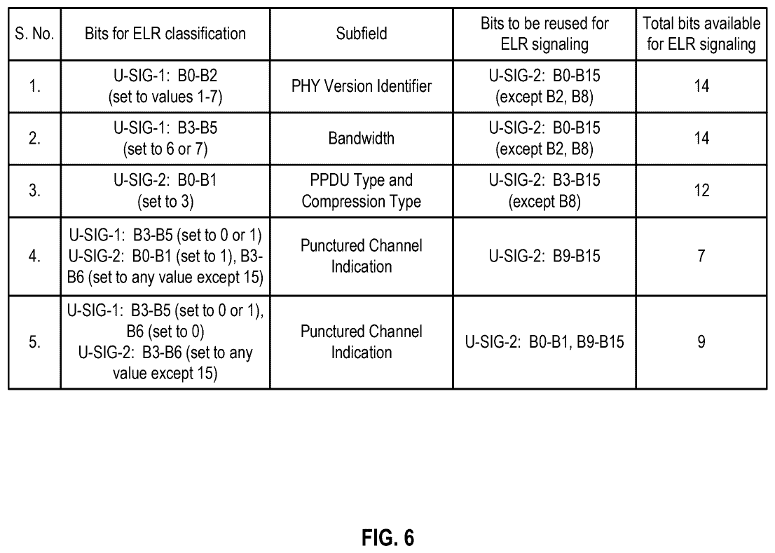

FIG. 3 illustrates an example of a universal signaling (U-SIG-1) field 300 including an ELR PPDU indication in accordance with an embodiment of the present disclosure. In this example, a U-SIG-1 field 300 of the U-SIG field 228 of FIG. 2 is illustrated. Examples of a U-SIG-2 field of the U-SIG field 228 are described with reference to FIG. 4 and FIG. 5. The subfields of the illustrated U-SIG-1 subfield and U-SIG-2 subfields 214 generally correspond to the U-SIG formats (e.g., for a MU PPDU) introduced in the 802.11be amendment to the IEEE 802.11 standard. The U-SIG-1 field 300 of the illustrated example includes a Version Identifier subfield 302, a PPDU BW subfield 304, an UL/DL subfield 306, a BSS Color subfield 308, a TXOP subfield 310, a Disregard bits subfield 312, and a Validate bit subfield (bit index (B25)) that is redefined as a Non-ELR mode indication 314. In addition, the Non-ELR mode indication 314 subfield is redefined from a version dependent subfield to a version independent subfield to provide forward compatibility with non-legacy versions of the IEEE 802.11 standard (subfields 302-310 are presently defined as version independent subfields). In an example, the Non-ELR mode indication 314 is set to a value of 0 to indicate an ELR PPDU format. Other examples of U-SIG-1 subfields (e.g., Version Identifier subfield 302) that can be redefined for use in ELR classification are described with reference to FIG. 6.

FIG. 4 illustrates an example of a U-SIG-2 field 400 including an ELR PPDU indication in accordance with an embodiment of the present disclosure. The U-SIG-2 field 400 of this example includes a PPDU Type And Compression Mode subfield 402 (bit index B0-B1), a Validate bit subfield 404 (bit index B2), a Punctured Channel Indication subfield 406 (bit index (B3-B7)), a Validate bit subfield 408 (bit index B8), an EHT-SIG MCS subfield 410, a Number of EHT-SIG Symbols subfield 412 (bit index (B11-B15)), a CRC in U-SIG subfield 414, and a Tail in U-SIG bit subfield 416.

In the illustrated example, the Number of EHT-SIG Symbols subfield 412 can be redefined as version independent subfield that is used to carry an ELR PPDU indication. For example, all 5 bits (B11-B15) can be set to 1 to indicate an ELR PPDU. In another example, the Punctured Channel Indication subfield 406 (bit index (B3-B7) is redefined to include an ELR PPDU indication (e.g., a value of 3 can be used to indicate an ELR PPDU format). In a further example, at least 3 of the bits of bit index (B11-B15) are set to 1 to indicate an ELR PPDU. In another example, the PPDU Type and Compression Mode subfield 402 of U-SIG-2 field 400 is redefined to provide an ELR PPDU indication (e.g., when bits B0-B1 are set to 3), bits B2-B12 are redefined to provide an association ID (STA-ID) value, and bits B13-B15 are redefined as ELR validate bits (e.g., all bits are set to 1 for an ELR PPDU) such that they overlap with Number of EHT-SIG Symbols subfield 412. In this example, when a UHR-ELR PPDU is classified as a non-ELR PPDU, the ELR validate bits will be processed as “Number of EHT/UHR-SIG Symbols”. Further, even if 2 bits are flipped with B13=1, the “Number of EHT/UHR-SIG Symbols”≥4 (minimum of 16 us from U-SIG-2) provides sufficient time for a receiver to process and detect an ELR PPDU.

As noted, an ELR PPDU may be received by a STA in a SNR region that is lower than a U-SIG decoding sensitivity, leading to a possibility of false CRC verification (e.g., of a CRC value carried in a CRC in U-SIG subfield of a U-SIG-2 field) when U-SIG content is decoded in error. In addition to the other schemes described herein, various additional approaches can be used to mitigate such false CRC verification. In an example, a receiver checks for a non-ELR only mode using indications that are distinct for a non-ELR PPDU. Such indications may include, for example, ELR PPDU indication bits and a PPDU BW subfield carrying values 1-5. In another example, a dual CRC check is performed to detect a non-ELR PPDU. In this example, in addition to the existing CRC in U-SIG subfield, a second CRC value is computed (e.g., calculated over all bits up to the TXOP subfield, all bits up to the PPDU Type and Compression Mode subfield, etc.). The second CRC value can be signaled, for example, in four bits of the Disregard subfield of a U-SIG-1 field. The CRC polynomial used to calculate the second CRC value can be the same as the existing 4-bit CRC polynomial, or a new polynomial may be utilized. In a further example, a new CRC value that covers the L-SIG field and a portion of the U-SIG field is calculated. In this example, the L-SIG field is included in the calculation field as it has a relatively high chance of producing false positives, which can lead to erroneous LENGTH determinations and potentially cause long and unnecessary backoff times.

In operation, a ELR-capable device receiving a PPDU generally needs to classify legacy PPDUs, non-ELR UHR PPDUs, and ELR PPDUs. The receiving device may be within or outside of the non-ELR communication range of an ELR PPDU transmitter. In order to simplify the ELR receiver design, a unified Rx Finite State Machine (FSM) can be defined. In an example of operation in which a U-SIG CRC is validated and a non-ELR PPDU is indicated in the U-SIG field, the unified Rx FSM checks whether the Rx RSSI is above a predetermined threshold. In another example, the unified Rx FSM checks whether there is a non-ELR indication. The unified Rx FSM may further check a CRC-1 value. If a check passes under one of these examples, processing of an ELR-MARK field can be omitted, and the ELR receiver can begin processing the received PPDU as a non-ELR PPDU. Otherwise, the ELR receiver can continue with ELR-MARK symbol detection to further confirm that the received PPDU is an ELR PPDU. In another example in which initial detection of an L-STF/L-LTF is successful, but a U-SIG CRC check fails, the ELR receiver can continue with ELR-MARK symbol detection to determine if the received PPDU is an ELR PPDU. In an example of a classification metric, the correlation of received tones with expected fixed values is utilized. In this example, if the correlation of these specific loaded tones is greater than a threshold value, a PPDU is classified as an ELR PPDU.

FIG. 5 illustrates another example of a U-SIG-2 field 500 including an ELR PPDU indication in accordance with an embodiment of the present disclosure. The U-SIG-2 field 500 of this example includes a subset of one or more of the subfields of a legacy U-SIG-2 field in combination with other subfields. In the illustrated example, the U-SIG-2 field 500 includes a STA-ID subfield 502 (bit index (B0-B10), a Number of EHT-SIG Symbols subfield 504 (bit index (B11-B15), a CRC in U-SIG subfield 506 (bit index (B16-B20), and a Tail in U-SIG subfield 508 (bit index (B21-B25)). In this example, the STA-ID subfield 502 signals a STA-ID value using various repurposed version dependent U-SIG-2 subfields, and the Number of EHT-SIG Symbols subfield 504 is used to provide an indication of an ELR PPDU format.

In another example, a PPDU Type and Compression Mode subfield (bit index (B0-B1) of a U-SIG-2 field is defined to provide an indication of an ELR PPDU format, and bits B2-B12 are redefined as a STA-ID subfield that carries a STA-ID value. In this example, one value of the PPDU Type and Compression Mode subfield is repurposed to indicate an ELR Value. For instance, a value of 3 is used for either UL/DL bit setting. In a further example, a value of 3 is used when the UL/DL bit is set to 0, and a value of 2 is used when the UL/DL bit is set to 1.

As described herein, in various embodiments the frame formats of U-SIG symbols or HE-SIG-A symbols are reused in the preamble of an ELR PPDU that includes novel ELR classification indications. In an example in which a U-SIG symbol is reused, a length field (L-Length % 3) of an L-SIG symbol is set to a value of 0, which aligns with the definition of U-SIG as it is expected to be present in all future/non-legacy formats. In an example in which a HE-SIG-A symbol having a multi-user (MU) format is reused, the L-Length 3% is set to a value of 2.

In various embodiments, the contents of a U-SIG/HE-SIG field (e.g., ELR PPDU indications and ELR signaling) can depend on operation of the CRC for the U-SIG/HE-SIG fields. In one example in which CRC verification fails, masking is performed on the CRC value to ensure failure (e.g., 4 pre-defined bits can be XORed with the generated CRC bits). In this example, all subfields/fields of U-SIG-1/HE-SIG-A1 and U-SIG-2/HE-SIG-A2 can be used for ELR signaling. Alternatively, one special symbol of 4 us (0.8 us CP) with 52 loaded tones (legacy tone mapping) or 56 loaded tones (HT/VHT tone mapping) instead of two U-SIG/HE-SIG-A symbols can be used for ELR signaling.

In another example in which the CRC verification (presumably) passes, the ELR PPDU sets a bandwidth (BW) of 20 MHz (U-SIG-1: B3-B5=0; HE-SIG-A1: B15-B17=0). In this example, the TXOP field definition is unchanged and can be dynamic. In a specific example, an ELR PPDU (format) indication is carried in U-SIG-1 bits B19-B24 (set to 0 for ELR classification). U-SIG-1 bits B13-B19 are used to carry TXOP information, with B19 set to 0. In this example, the TXOP value can be set using the following criteria: (1) a value of 127 is not allowed; (2) if the TXVECTOR parameter TXOP_DURATION is less than 256, set value to 2× floor(TXOP_DURATION/8); (3) a TXOP_DURATION value of 256 to 512 is mapped to 512; (4) else if TXOP_DURATION is less than 4608, set value to 2× floor((TXOP_DURATION−512)/128)+1); (5) otherwise not allowed.

In another specific example in which a Validate bit(s) is utilized, an ELR PPDU indication is carried in U-SIG-1 bits B20-B25 (set to 0 for ELR classification). In this example, all bits (B13-B19) of the TXOP field are used to carry TXOP information. In another example in which the ELR PPDU carries HE-SIG-A symbols, HE-SIG-A2 bits B8-B13 are set to 0 to indicate an ELR PPDU. If a Validate bit is utilized, the ELR PPDDU indicator can be carried in HE-SIG-A2 bits B7-B12 (set to 0).

In another example, the TXOP value is set to 127 (Unspecified). In this example, an additional 5 or 6 bits that were set to 0 in the previous examples can be used for ELR signaling. In examples such as described above, ELR classification can be carried out in various ways. In an example in which Validate bits are utilized, U-SIG-1 bit B25 and U-SIG-2 bits B2 and B8 are used for ELR classification. In this example, cach of the bits can be set to 0 or, alternatively, any combination of bit values except all 1's can be used to indicate an ELR PPDU. In this example, bits that are available for signaling ELR-related fields include U-SIG-2 bits B0-B1 (PPDU Type and Compression Mode), bits B3-B7 (Punctured Channel Indication) and bits B9-B15 (EHT-SIG MCS and Number of EHT-SIG Symbols) (14 bits total). In an example in which HE-SIG fields are used in an ELR PPDU, HE-SIG-A2 bit B7 can be set to 1 to indicate an ELR PPDU format. In this example, bits that are available for signaling ELR-related fields include HE-SIG-A1 bits B0-B25 (except bits B0 and B15-B17) and HE-SIG-A2 bits B13-B15 (25 bits total).

In the approaches to ELR classification described herein, various bits/fields are repurposed for use in ELR signaling. In an example, the information conveyed by ELR signaling can be AP independent or AP dependent. With AP independent signaling, a unique sequence can be loaded onto the ELR signaling fields for use by all recipient devices to classify an ELR PPDU. With AP dependent signaling, the conveyed information is AP dependent, and other recipient APs are generally unable to classify the ELR PPDU using the ELR signaling. In an example, a STA-ID of an AP can be transmitted using ELR signaling bits (e.g., 11 or 12 LSB bits of a BSSID can be used to represent an AP). In another example, 11 or 12 random bits can be generated for use as an STA-ID. These random bits con be communicated to STAs in a similar manner to BSS Color. In these examples, ELR signaling generated by either an AP or a STA can be loaded with the STA-ID of an AP.

FIG. 6 is a table illustrating additional examples of ELR PPDU indication bits and ELR signaling bits of U-SIG fields in accordance with embodiments of the present disclosure. In a first example (or scheme), U-SIG-1 bits B0-B2 (Version Identifier subfield) are redefined to indicate an ELR PPDU. In this example, U-SIG-2 bits B0-B15 (except Validate bits B2 and B8) are reused for ELR signaling (e.g., of a STA-ID value or other information). In a second example, U-SIG-1 bits B3-B5 (set to 6 or 7) are used to indicate an ELR PPDU, and U-SIG-2 bits B0-B15 (except Validate bits B2 and B8) are reused for ELR signaling. In a third example, U-SIG-2 bits B0-B1 (e.g., set to 3) are used to indicate an ELR PPDU, and U-SIG-2 bits B3-B15 (except Validate bit B8) provide ELR signaling.

In a fourth example, U-SIG-1 bits B3-B5 (set to 0 or 1), U-SIG-2 bits B0-B1 (set to 1) and B3-B6 (set to any value except 15) are redefined to indicate an ELR PPDU, and U-SIG-2 bits B9-B15 are reused for ELR signaling. In a fifth example, U-SIG-1 bits B3-B5 (set to 0 or 1), U-SIG-1 bit B6 (set to 0), and U-SIG-2 bits B3-B6 (set to any value except 15) are redefined to indicate an ELR PPDU, and U-SIG-2 bits B0-B1 and B9-B15 are reused for ELR signaling.

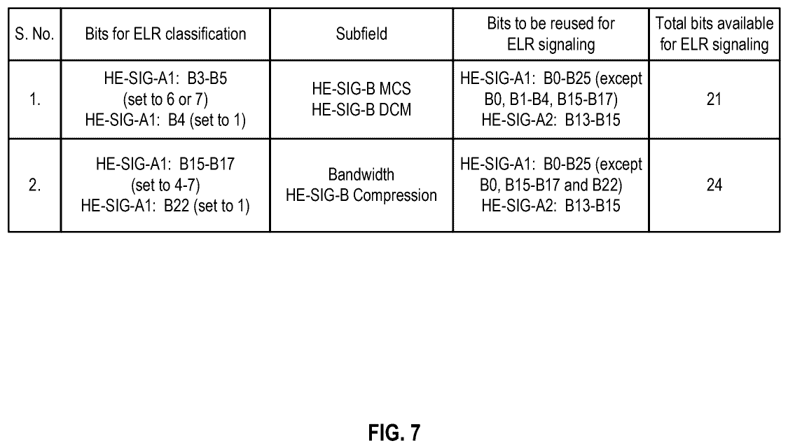

FIG. 7 is a table illustrating examples of ELR PPDU indication bits and ELR signaling bits of High Efficiency SIG (HE-SIG) fields in accordance with embodiments of the present disclosure. In an example, HE-SIG-A1 bits B3-B5 (set to 6 or 7, with B4 set to 1) of the HE-SIG-B MCS and DCM subfields are redefined to indicate an ELR PPDU, and HE-SIG-A1 bits B0-B25 (except, e.g., bits B0, B1-B4, and B15-B17) and HE-SIG-A2 bits B13-B15 are reused for ELR signaling. In another example, HE-SIG-A1 bits B15-B17 (set to 4-7) and B22 (set to 1) of the Bandwidth and HE-SIG-B Compression subfields are redefined to indicate an ELR PPDU, and HE-SIG-A1 bits B0-B25 (except, e.g., bits B0, B1-B4, B15-B17) and HE-SIG-A2 bits B13-B15 are reused for ELR signaling.

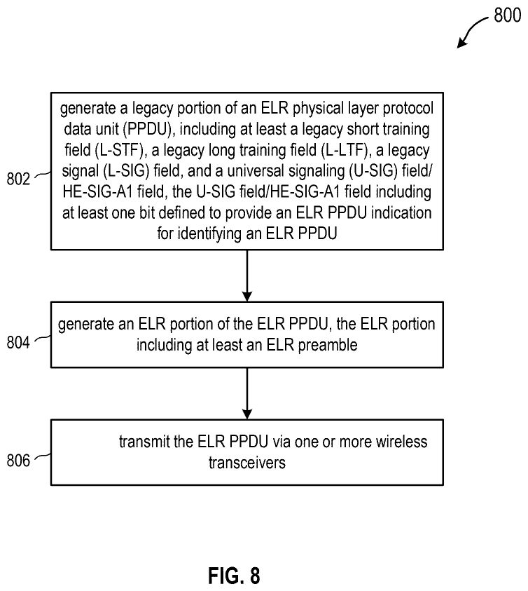

FIG. 8 is a logic diagram 800 illustrating an example process for generating an ELR PPDU including an ELR PPDU indication in accordance with an embodiment of the present disclosure. The illustrated functions can be performed by a wireless communication device, such as an AP 102 or a client station 116 described with reference to FIG. 1, to generate and transmit an ELR PPDU for reception by another wireless device.

The illustrated method begins at step 802 where the wireless communications device generates a legacy portion of an ELR PPDU. In an example, the legacy portion comprises one or more of a legacy short training field (L-STF), a legacy long training field (L-LTF), a legacy signal (L-SIG) field, and a universal signaling (U-SIG) field. In this example, the U-SIG field includes at least one bit defined to provide an ELR PPDU indication that can be used by a receiving device to classify/identify an ELR PPDU. A U-SIG subfield including one or more bits that provide an ELR PPDU indication may be redefined in the 802.11bn amendment to the IEEE 802.11 standard from a version dependent subfield to a version independent subfield to provide forward compatibility. Various examples of the content and organization of U-SIG fields are described with reference to FIGS. 3-6. In another example, the U-SIG field includes a U-SIG-1 field and a U-SIG-2 field. In addition to an ELR PPDU indication, the U-SIG-2 field may include an association ID (STA-ID) value (e.g., including either the 11 LSB bits of a Basic Service Set Identifier (BSSID) or a randomly generated value that is communicated to recipient devices).

In another example, the legacy portion comprises an L-STF, an L-LTF, an L-SIG field, and a High Efficiency SIG (HE-SIG) field (e.g., a HE-SIG-A1 field) including at least one bit defined to provide an ELR PPDU indication for identifying an ELR PPDU. Examples of a HE-SIG field are described with refence to FIG. 7. In these examples, various bits in a (legacy) U-SIG field/HE-SIG field may be repurposed to carry ELR signaling information.

The legacy portion/legacy preamble of the ELR PPDU may further include an additional symbol (e.g., an “ELR-MARK field”) that follows the U-SIG field of the ELR PPDU and precedes the ELR portion of the ELR PPDU. Continuing with this example, the additional symbol may include at least one of a BSS color indication and a (tone/symbol) sequence that indicates an ELR PPDU.

The method continues at step 804 where the wireless communication device generates an ELR portion of the ELR PPDU, the ELR portion including at least an ELR preamble. In an example, the ELR portion includes a UHR short training field (UHR-STF), a UHR long training field (UHR-LTF), an ELR signal (ELR-SIG) field, and a data field. In a non-limiting example, the ELR-SIG field includes an ELR-SIG-1 subfield and an ELR-SIG-2 subfield carried in separate OFDM symbols. In another example, the ELR-SIG field includes a single symbol.

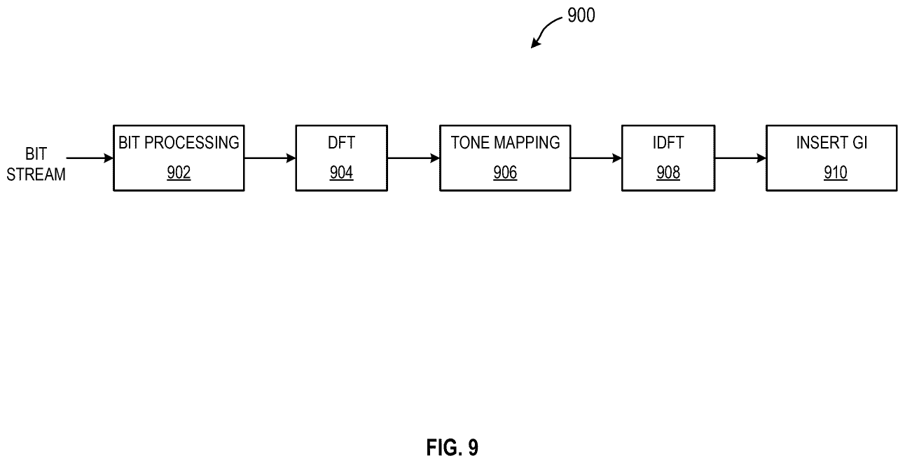

The method continues at step 806, where the wireless communication device transmits the ELR PPDU, via one or more wireless transceivers, for reception by one or more other wireless communication devices (e.g., devices at an extended range). A recipient device may respond with a similarly constructed ELR PPDU. In an example, the ELR PPDU and fields thereof are transmitted as one or more waveforms, and one or more repetitions of a field may be transmitted to increase a signal-to-noise ratio (SNR) of the ELR portion of the ELR PPDU to facilitate decoding of the field. For example, repetition of a field (e.g., as described with reference to FIG. 9) may increase an associated SNR by greater than 3 dB through averaging of signals associated with the repetitions.

FIG. 9 illustrates example functions 900 associated with single carrier-frequency division multiplexed (SC-FDM) transmission of the ELR-SIG field 224 and ELR Data field 226 in accordance with an embodiment (e.g., using the ELR PPDU 200 of FIG. 2 as an example). The functions 900 include bit processing 902 a binary sequence/stream associated with a field of the ELR PPDU, a discrete Fourier transform (DFT) 904, a tone mapping 906, an inverse DFT (IDFT) 908, and guard band insertion 910. At 902, the bit processing 902 performs one or more of encoding, scrambling, and/or modulation of a binary sequence of a field in a time domain. At 904, a DFT of the processed binary sequence of the ELR-SIG field 224/ELR Data field 226 is generated followed by a tone mapping 906. The tone mapping 906 operates to populate the processed information bits in the frequency domain onto subcarriers which span a channel bandwidth such as a 20 MHz channel. Further, the population onto subcarriers may include mapping the processed binary sequence in the frequency domain to a resource unit which defines a plurality of tones for carrying the data. The tones can be contiguous or distributed. In an example, the bit processing 902 performs a precoding of the information bits prior to the tone mapping 906 to reduce a peak to average ratio (PAPR) of a waveform prior to transmission. The IDFT 908 generates a SC-FDM symbol which spans a channel bandwidth and the guard band insertion 910 inserts guard intervals (e.g., to separate the symbols from interference). In an example, the guard interval for an ELR-SIG symbol is fixed at 0.8 us, 1.6 us or 3.2 us. SC-FDM can be easily extended to a multiple user case, where each user is assigned to a subset of tones in the resource unit, i.e., each wireless device modulates its data (after DFT) onto a different set of tones to facilitate extending range for uplink (UL) transmissions to multiple clients. For SC-FDM (A) mode, in one variant, the ELR-SIG field 224 may be transmitted with SC-TDM, while the ELR Data field 226 may be transmitted with SC-FDM.

A tone map for the ELR-SIG field 224 and ELR Data field 226 transmitted using SC-FDM may be arranged as a 20 MHz ELR PPDU: ELR-SIG field 224 and ELR Data field 226 can be defined as one or more of an 802.11a/g tone plan, e.g., 64-point FFT with 48 loaded data tones and 4 pilot tones, an 802.11n/ac 20 MHz tone plan, e.g., 64-point FFT with 52 loaded data tones and 4 pilot tones (or 56 loaded data tones), or an 802.11ax/be 20 MHz tone plan, e.g., coded bit repetition using 256-point FFT and 234 loaded data tones and 8 pilot tones, or a sparse tone loading, e.g., 256-point FFT with 52 or 56 loaded data tones spaced every four tones (with channel estimation obtained from L-LTF, L-SIG, RL-SIG and/or an ELR-MARK subfield), etc. The tones may be subcarriers with a predefined frequency to carry indications of bits in fields of the ELR PPDU 200.

In another example, a wider bandwidth ELR PPDU 200 may be defined for a spectrum with a low power spectral density (PSD) requirement, e.g. 6 GHz low power indoor (LPI) operation. The ELR preamble may be transmitted in a 20 MHz bandwidth. To accommodate coexisting with wireless devices with different operating bandwidths, a wide bandwidth ELR preamble may be defined based on repetition of the 20 MHz ELR preamble across entire signal BW, e.g., 80 MHz, or a per-20 MHz tone polarity change can be applied to a phase of a tone which is waveform modulated with one or more bits of a binary sequence in the repetitions of the ELR preamble. The polarity change of −1 may change the phase of a waveform by 180 degrees while a polarity change of 1 may not change the phase of a waveform by 180 degrees. The changes in polarity may be known to the receiver to remove the polarity changes during a decoding process. The term repetition, repeated, and similar variations as used herein with respect to a field means that tones of two fields are the same after any applied polarity is removed.

In another example, the binary sequence of one or more fields of the ELR portion of the ELR PPDU 200 may be further repeated to improve communication range. Further, a binary sequence of the ELR portion may be defined as a waveform with OFDM modulation. The repetition may be in a time domain or in a frequency domain. In an example, the repetition (also referred to as duplication) may be a repetition of one or more orthogonal frequency division multiplexed/multiple access (OFDM/A) symbols in time with a same binary sequence, a repetition in frequency of a same binary sequence in one or more orthogonal frequency division multiplexed/multiple access (OFDM/A) symbols, or a repetition in time and frequency.

While the innovate aspects of the present disclosure have been generally described in the context of the 802.11bn amendment, and future generations, of the IEEE 802.11 standard, a person having ordinary skill in the art will readily recognize that teachings and concepts herein may be applied to other wireless networks and standards including, for example, Long Term Evolution (LTE) standards and Bluetooth standards.

The innovative methods and apparatus illustrated in the drawings and described hercin provide for reliable long range wireless communications. In an illustrative, non-limiting embodiment, a method for performing an Enhanced Long Range (ELR) wireless communication is provided. The method includes generating, by a first device, a legacy portion of an ELR physical layer protocol data unit (PPDU), the legacy portion including at least a legacy short training field (L-STF), a legacy long training field (L-LTF), a legacy signal (L-SIG) field, and a universal signaling (U-SIG) field. The U-SIG field includes at least one bit defined to provide an ELR PPDU indication for identifying an ELR PPDU. The method further includes generating, by the first device, an ELR portion of the ELR PPDU, the ELR portion including an ELR preamble. The first device of this method transmits the ELR PPDU over a wireless interface for reception by a second device.

The method of this embodiment includes optional aspects. With one optional aspect, the ELR PPDU indication of the U-SIG field is defined in the 802.11bn amendment to the IEEE 802.11 standard as a version independent subfield of the U-SIG field. With another optional aspect, the U-SIG field includes a U-SIG-1 field and a U-SIG-2 field, and the ELR PPDU indication includes bit index (B25) of the U-SIG-1 field. In a further optional aspect, the U-SIG field includes a U-SIG-1 field and a U-SIG-2 field, and the ELR PPDU indication includes at least one of bit index (B2) of U-SIG-2 field or bit index (B8) of the U-SIG-2 field. With another optional aspect, the ELR PPDU indication includes a defined value carried in a fixed number of bit locations that overlap with bit locations of a Number of EHT-SIG symbols subfield of the U-SIG field, and the Number of EHT-SIG symbols subfield is a version independent subfield of the IEEE 802.11 standard. In another optional aspect, the U-SIG field includes a U-SIG-1 field and a U-SIG-2 field, and the ELR PPDU indication includes a defined value of a PPDU Type And Compression Mode subfield carried in bit index (B0-B1) of the U-SIG-2 field.

In another optional aspect of this embodiment, one or more subfields of the U-SIG field carry ELR signaling information, the one or more subfields including a PPDU Bandwidth (BW) subfield, an Uplink/Downlink (UL/DL) subfield, a Basic Service Sct (BSS) Color subfield, or a Transmit Opportunity (TXOP) subfield. In a further optional aspect, the U-SIG field includes a U-SIG-1 field and a U-SIG-2 field, and wherein the U-SIG-2 field includes an association ID (STA-ID) value. In yet another optional aspect, the STA-ID value includes either the 11 LSB bits of a Basic Service Set Identifier (BSSID) or a randomly generated value. In another optional aspect, the U-SIG field is comprised of two symbols and the legacy portion further includes a third symbol following the U-SIG field, the third symbol including at least one of a sequence that indicates an ELR PPDU or a BSS color indication.

With another illustrative, non-limiting embodiment, a communication device includes one or more wireless transceivers, memory, and one or more processing modules operably coupled to the one or more wireless transceivers and the memory. The one or more processing modules are configured to generate a legacy portion of an ELR physical layer protocol data unit (PPDU), the legacy portion including a legacy short training field (L-STF), a legacy long training field (L-LTF), a legacy signal (L-SIG) field, and a universal signaling (U-SIG) field. The U-SIG field includes at least one bit defined to provide an ELR PPDU indication for identifying an ELR PPDU. The one or more processing modules of the communication device are further configured to generate an ELR portion of the ELR PPDU including an ELR preamble, and transmit the ELR PPDU via the one or more wireless transceivers.

This embodiment includes optional aspects. With one optional aspect, the ELR PPDU indication of the U-SIG field is defined in the 802.11bn amendment to the IEEE 802.11 standard as a version independent subfield of the U-SIG field. With another optional aspect, the U-SIG field includes a U-SIG-1 field and a U-SIG-2 field, and wherein the ELR PPDU indication includes bit index (B25) of the U-SIG-1 field. In yet another optional aspect, the U-SIG field includes a U-SIG-1 field and a U-SIG-2 field, and the ELR PPDU indication includes at least one of bit index (B2) of U-SIG-2 field or bit index (B8) of the U-SIG-2 field. In a further optional aspect, the ELR PPDU indication includes a defined value carried in a fixed number of bit locations that overlap with bit locations of a Number of EHT-SIG symbols subfield of the U-SIG field, and the Number of EHT-SIG symbols subfield is a version independent subfield as defined in the 802.11bn amendment to the IEEE 802.11 standard. With another optional aspect, the U-SIG field includes a U-SIG-1 field and a U-SIG-2 field, and the ELR PPDU indication includes a defined value of a PPDU Type And Compression Mode subfield carried in bit index (B0-B1) of the U-SIG-2 field. In yet another optional aspect, one or more subfields of the U-SIG field carry ELR signaling information. In a further optional aspect, the U-SIG field includes a U-SIG-1 field and a U-SIG-2 field, and the U-SIG-2 field includes an association ID (STA-ID) value.

With another illustrative, non-limiting embodiment, a method for performing an Enhanced Long Range (ELR) wireless communication is provided. The method includes generating, by a first device, a legacy portion of an ELR physical layer protocol data unit (PPDU), the legacy portion including a legacy short training field (L-STF), a legacy long training field (L-LTF), a legacy signal (L-SIG) field, and a High Efficiency SIG (HE-SIG) field. The HE-SIG field includes at least one bit defined to provide an ELR PPDU indication for identifying an ELR PPDU. The method further includes generating, by the first device, an ELR portion of the ELR PPDU, the ELR portion including an ELR preamble. The method further includes transmitting the ELR PPDU over a wireless interface for reception by a second device. In an optional aspect of this third embodiment, the HE-SIG field further includes ELR signaling information.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may further be used herein, the term(s) “arranged to”, “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with” includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”, “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for performing an Enhanced Long Range (ELR) wireless communication, comprising:
generating, by a first device, a legacy portion of an ELR physical layer protocol data unit (PPDU), the legacy portion including at least a legacy short training field (L-STF), a legacy long training field (L-LTF), a legacy signal (L-SIG) field, and a universal signaling (U-SIG) field, wherein the U-SIG field includes at least one bit defined to provide an ELR PPDU indication for identifying an ELR PPDU;
generating, by the first device, an ELR portion of the ELR PPDU, the ELR portion including an ELR preamble; and
transmitting the ELR PPDU over a wireless interface for reception by a second device.

2. The method of claim 1, wherein the ELR PPDU indication of the U-SIG field is defined in the 802.11bn amendment to the IEEE 802.11 standard as a version independent subfield of the U-SIG field.

3. The method of claim 2, wherein the U-SIG field includes a U-SIG-1 field and a U-SIG-2 field, and wherein the ELR PPDU indication includes bit index (B25) of the U-SIG-1 field.

4. The method of claim 2, wherein the U-SIG field includes a U-SIG-1 field and a U-SIG-2 field, and wherein the ELR PPDU indication includes at least one of bit index (B2) of the U-SIG-2 field or bit index (B8) of the U-SIG-2 field.

5. The method of claim 1, wherein the ELR PPDU indication includes a defined value carried in a fixed number of bit locations that overlap with bit locations of a Number of EHT-SIG symbols subfield of the U-SIG field, and wherein the Number of EHT-SIG symbols subfield is a version independent subfield of the IEEE 802.11 standard.

6. The method of claim 1, wherein the U-SIG field includes a U-SIG-1 field and a U-SIG-2 field, and wherein the ELR PPDU indication includes a defined value of a PPDU Type And Compression Mode subfield carried in bit index (B0-B1) of the U-SIG-2 field.

7. The method of claim 1, wherein one or more subfields of the U-SIG field carry ELR signaling information, the one or more subfields including a PPDU Bandwidth (BW) subfield, an Uplink/Downlink (UL/DL) subfield, a Basic Service Set (BSS) Color subfield, or a Transmit Opportunity (TXOP) subfield.

8. The method of claim 1, wherein the U-SIG field includes a U-SIG-1 field and a U-SIG-2 field, and wherein the U-SIG-2 field includes an association ID (STA-ID) value.

9. The method of claim 8, wherein the STA-ID value includes either the 11 LSB bits of a Basic Service Set Identifier (BSSID) or a randomly generated value.

10. The method of claim 1, wherein the U-SIG field is comprised of two symbols and the legacy portion further includes a third symbol following the U-SIG field, the third symbol including at least one of:
a sequence that indicates an ELR PPDU; or
a Basic Service Set (BSS) color indication.

11. A communication device, comprising:
one or more wireless transceivers;
memory; and
one or more processing modules operably coupled to the one or more wireless transceivers and the memory, wherein the one or more processing modules are configured to:
generate a legacy portion of an ELR physical layer protocol data unit (PPDU), the legacy portion including at least a legacy short training field (L-STF), a legacy long training field (L-LTF), a legacy signal (L-SIG) field, and a universal signaling (U-SIG) field, wherein the U-SIG field includes at least one bit defined to provide an ELR PPDU indication for identifying an ELR PPDU;
generate an ELR portion of the ELR PPDU, the ELR portion including an ELR preamble; and
transmit the ELR PPDU via the one or more wireless transceivers.

12. The communication device of claim 11, wherein the ELR PPDU indication of the U-SIG field is defined in the 802.11bn amendment to the IEEE 802.11 standard as a version independent subfield of the U-SIG field.

13. The communication device of claim 12, wherein the U-SIG field includes a U-SIG-1 field and a U-SIG-2 field, and wherein the ELR PPDU indication includes bit index (B25) of the U-SIG-1 field.

14. The communication device of claim 12, wherein the U-SIG field includes a U-SIG-1 field and a U-SIG-2 field, and wherein the ELR PPDU indication includes at least one of bit index (B2) of U-SIG-2 field or bit index (B8) of the U-SIG-2 field.

15. The communication device of claim 11, wherein the ELR PPDU indication includes a defined value carried a fixed number of bit locations that overlap with bit locations of a Number of EHT-SIG symbols subfield of the U-SIG field, and wherein the Number of EHT-SIG symbols subfield is a version independent subfield as defined in the 802.11bn amendment to the IEEE 802.11 standard.

16. The communication device of claim 11, wherein the U-SIG field includes a U-SIG-1 field and a U-SIG-2 field, and wherein the ELR PPDU indication includes a defined value of a PPDU Type And Compression Mode subfield carried in bit index (B0-B1) of the U-SIG-2 field.

17. The communication device of claim 11, wherein one or more subfields of the U-SIG field carry ELR signaling information.

18. The communication device of claim 11, wherein the U-SIG field includes a U-SIG-1 field and a U-SIG-2 field, and wherein the U-SIG-2 field includes an association ID (STA-ID) value.

19. A method for performing an Enhanced Long Range (ELR) wireless communication, comprising:
generating, by a first device, a legacy portion of an ELR physical layer protocol data unit (PPDU), the legacy portion including at least a legacy short training field (L-STF), a legacy long training field (L-LTF), a legacy signal (L-SIG) field, and a High Efficiency SIG (HE-SIG) field, wherein the HE-SIG field includes at least one bit defined to provide an ELR PPDU indication for identifying an ELR PPDU;
generating, by the first device, an ELR portion of the ELR PPDU, the ELR portion including an ELR preamble; and
transmitting the ELR PPDU over a wireless interface for reception by a second device.

20. The method of claim 19, wherein the HE-SIG field further includes ELR signaling information.
